(19) United States
(12) Patent Application Publication
(10) Pub. No.: US 2026/0084171 A1
(43) Pub. Date: Mar. 26, 2026

(54) Gantry System for Applying Masks

(71) Applicant: Vitro Fabricación de Máquinas, S.A. de C.V, Monterrey (MX)

(72) Inventors: Adrián Enrique Macouzet Díaz Leal, Tlalnepantla (MX); Gustavo Abraham Chavez Guerrero, Monterrey (MX)

(21) Appl. No.: 19/226,968

(22) Filed: Jun. 3, 2025

Related U.S. Application Data
(60) Provisional application No. 63/655,835, filed on Jun. 4, 2024.

(51) Int. Cl. B05B 12/20; B25J 9/16; B25J 11/00

(52) U.S. Cl. CPC B05B 12/20; B25J 9/1679; B25J 11/0075

(57) ABSTRACT

A method for masking substrates includes: providing a substrate including a first surface and an opposing second surface, the substrate having a first substrate identity from a plurality of substrate identities; automatically detecting, with at least one processor, that the substrate has the first substrate identity; in response to detecting that the substrate has the first substrate identity, determining, with at least one processor, a first mask of a plurality of masks associated with the first substrate identity based on associations stored in a database between the plurality of substrate identities and the plurality of masks; in response to determining the first mask, automatically retrieving, with at least one mechanical arm, the first mask; and placing, with the at least one mechanical arm, the first mask over the first surface.

### CROSS-REFERENCE TO RELATED APPLICATION

This application claims priority to U.S. Provisional Patent Application No. 63/655,835 filed Jun. 4, 2024, the disclosure of which is hereby incorporated by reference in its entirety.

### BACKGROUND

### Field

The present disclosure is directed to a method and system for masking substrates.

### Technical Considerations

Coated substrates are often manufactured with a first portion of the substrate coated with a first coating and a second portion of the substrate uncoated or coated with a second coating. Masks can be used to coat such substrates having first and second portions with different coating characteristics. Within the same manufacturing facility, a plurality of different coated substrate products can be produced, with each product having a different coating arrangement and requiring a different mask to produce.

### SUMMARY OF THE DISCLOSURE

According to some non-limiting aspects of the disclosure, a method for masking substrates includes: providing a substrate including a first surface and an opposing second surface, the substrate having a first substrate identity from a plurality of substrate identities; automatically detecting, with at least one processor, that the substrate has the first substrate identity; in response to detecting that the substrate has the first substrate identity, determining, with at least one processor, a first mask of a plurality of masks associated with the first substrate identity based on associations stored in a database between the plurality of substrate identities and the plurality of masks; in response to determining the first mask, automatically retrieving, with at least one mechanical arm, the first mask; and placing, with the at least one mechanical arm, the first mask over the first surface.

In some non-limiting aspects, with the first mask over the first surface, at least one first portion of the first surface may be blocked by the first mask and at least one second portion of the first surface may be not blocked by the first mask.

In some non-limiting aspects, the method may further include applying at least one coating composition over the first mask such that the coating composition adheres to the first surface on the at least one second portion of the first surface and does not adhere to the first surface on the at least one first portion of the first surface.

In some non-limiting aspects, the method may further include removing the first mask after applying the at least one coating composition.

In some non-limiting aspects, the coating composition may include at least one of a solar control coating, an antireflective coating, a low emissivity coating, or any combination thereof.

In some non-limiting aspects, the substrate may include a glass sheet.

In some non-limiting aspects, automatically detecting that the substrate has the first substrate identity may include automatically detecting a dimension of the substrate, where the database may store associations between substrate dimensions and the plurality of substrate identities.

In some non-limiting aspects, automatically retrieving the first mask with the at least one mechanical arm may include: moving the at least one mechanical arm to a first location including the first mask; engaging the first mask with the at least one mechanical arm; and moving the at least one mechanical arm to the substrate.

In some non-limiting aspects, the method may further include: providing a second substrate including a first surface and an opposing second surface, the second substrate having a second substrate identity from the plurality of substrate identities; automatically detecting, with at least one processor, that the second substrate has the second substrate identity; in response to detecting that the second substrate has the second substrate identity, determining, with at least one processor, a second mask of the plurality of masks associated with the second substrate identity based on the associations stored in the database between the plurality of substrate identities and the plurality of masks; in response to determining the second mask, automatically retrieving, with the at least one mechanical arm, the second mask; and placing, with the at least one mechanical arm, the second mask over the first surface of the second substrate.

In some non-limiting aspects, the method may further include: in response to placing the first mask over the first surface, detecting, with at least one processor, correct alignment of the first mask over the first substrate.

According to some non-limiting aspects of the disclosure, a system for masking substrates includes a database storing associations between a plurality of substrate identities and a plurality of masks; at least one processor configured to: automatically detect that a substrate has a first substrate identity of the plurality of substrate identities, the substrate including a first surface and an opposing second surface; and in response to detecting that the substrate has the first substrate identity, determine a first mask of the plurality of masks associated with the first substrate identity based on the associations stored in the database; and at least one mechanical arm configured to: in response to determining the first mask, automatically retrieve the first mask; and place the first mask over the first surface.

In some non-limiting aspects, with the first mask over the first surface, at least one first portion of the first surface may be blocked by the first mask and at least one second portion of the first surface may be not blocked by the first mask.

In some non-limiting aspects, the system may further include an applicator configured to apply at least one coating composition over the first substrate such that the coating composition adheres to the first surface on the at least one second portion of the first surface and does not adhere to the first surface on the at least one first portion of the first surface.

In some non-limiting aspects, the system may further include a remover configured to remove the first mask after applying the at least one coating composition.

In some non-limiting aspects, the coating composition may include at least one of a solar control coating, an antireflective coating, a low emissivity coating, or any combination thereof.

In some non-limiting aspects, the substrate may include a glass sheet.

In some non-limiting aspects, automatically detecting that the substrate has the first substrate identity may include the at least one processor automatically detecting a dimension of the substrate, where the database may store associations between substrate dimensions and the plurality of substrate identities.

In some non-limiting aspects, wherein automatically retrieving the first mask with the at least one mechanical arm may include the at least one mechanical arm being configured to: move the at least one mechanical arm to a first location including the first mask; engage the first mask with the at least one mechanical arm; and move the at least one mechanical arm to the substrate.

In some non-limiting aspects, the at least one processor may be further configured to: automatically detect that a second substrate has a second substrate identity of the plurality of substrate identities, the second substrate including a first surface and an opposing second surface; in response to detecting that the second substrate has the second substrate identity, determine a second mask of the plurality of masks associated with the second substrate identity based on the associations stored in the database; and where the at least one mechanical arm may be further configured to: in response to determining the second mask, automatically retrieve the second mask; and place the second mask over the first surface of the second substrate.

In some non-limiting aspects, the at least one processor may be further configured to: in response to placing the first mask over the first surface, detect correct alignment of the first mask over the first substrate.

### BRIEF DESCRIPTION OF THE DRAWINGS

The disclosure will be described with reference to the following drawing figures wherein like reference numbers identify like parts throughout.

FIGS. 1A-1D show schematic diagrams of a plurality of substrates, according to some aspects of the disclosure;

FIGS. 2A-2D show schematic diagrams of a plurality of masks, according to some aspects of the disclosure;

FIGS. 3A-3D show schematic diagrams (top views) of substrates undergoing a process for producing a coated substrate using a mask, according to some aspects of the disclosure;

FIGS. 4A-4D show schematic diagrams (cross-sectional views) of substrates undergoing a process for producing a coated substrate using a mask, according to some aspects of the disclosure, wherein FIGS. 3A-3D correspond to FIGS. 4A-4D, respectively;

FIGS. 5A-5F show schematic diagrams of a gantry system for producing a coated substrate, according to some aspects of the disclosure;

FIGS. 6A-6C show schematic diagrams of various embodiments of a mechanical arm used in a gantry system for producing a coated substrate, according to some aspects of the disclosure;

FIG. 7 shows a step diagram of a process for producing a coated substrate using a mask, according to some aspects of the disclosure; and

FIG. 8 shows a schematic diagram of example components of a device used in connection with some aspects of the disclosure.

### DETAILED DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

Further, as used herein, the terms “formed over”, “deposited over”, “arranged over”, or “provided over” mean formed, deposited, arranged, or provided on but not necessarily in contact with the surface. For example, a coating layer “arranged over” a substrate does not preclude the presence of one or more other coating layers or films of the same or different composition located between the formed coating layer and the substrate.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

Additionally, all documents, such as, but not limited to, issued patents and patent applications, referred to herein are to be considered to be “incorporated by reference” in their entirety.

The disclosure relates to a method for masking substrates, comprising: providing a substrate comprising a first surface and an opposing second surface, the substrate having a first substrate identity from a plurality of substrate identities; automatically detecting, with at least one processor, that the substrate has the first substrate identity; in response to detecting that the substrate has the first substrate identity, determining, with at least one processor, a first mask of a plurality of masks associated with the first substrate identity based on associations stored in a database between the plurality of substrate identities and the plurality of masks; in response to determining the first mask, automatically retrieving, with at least one mechanical arm, the first mask; and placing, with the at least one mechanical arm, the first mask over the first surface.

The disclosure also relates to a system for masking substrates, comprising: a database storing associations between a plurality of substrate identities and a plurality of masks; at least one processor configured to: automatically detect that a substrate has a first substrate identity of the plurality of substrate identities, the substrate comprising a first surface and an opposing second surface; and in response to detecting that the substrate has the first substrate identity, determine a first mask of the plurality of masks associated with the first substrate identity based on the associations stored in the database; and at least one mechanical arm configured to: in response to determining the first mask, automatically retrieve the first mask; and place the first mask over the first surface.

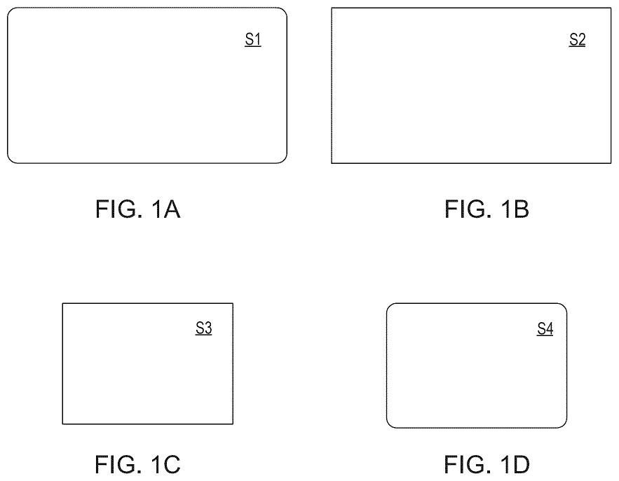

Referring to FIGS. 1A-1D, a plurality of substrates S1-S4 are shown according to some aspects of the disclosure. The substrates S1-S4 may initially be uncoated but may be coated with at least one coating material using the systems and according to the processes described herein. The substrates S1-S4 may be made of the same or different materials. The substrates S1-S4 may have the same of different shapes and/or sizes (e.g., dimensions including lengths, widths, thicknesses, and the like). The substrates S1-S4 may have the same of different intended coating arrangements intended to be applied thereover.

The material of the substrates S1-S4 may include, for example, glass, plastic, metal, ceramic, and/or any combination thereof. The substrate 102 may comprise a glass sheet. In some non-limiting embodiments or aspects, the glass may comprise automotive glass, such as glass used in at least one of a windshield, a passenger or driver door window, a rear window, a sun or moon roof, and/or the like. In some non-limiting embodiments or aspects, the glass may comprise architectural glass used in architectural components, such as residential and/or commercial buildings.

Non-limiting examples of suitable plastic materials include acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof.

Non-limiting examples of suitable glass materials include conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155. The glass materials may comprise a low iron glass, such as a glass having a total iron Fe₂O₃ in the range of greater than 0.00 to 0.10 wt. % or less than 0.02 wt. %. The low iron glass may be less green and have a high visible light transmittance.

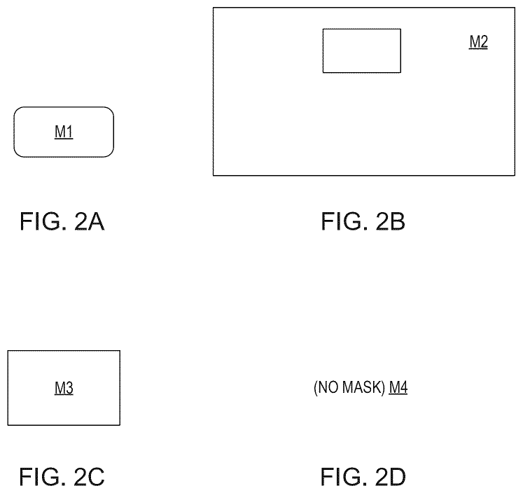

Referring to FIGS. 2A-2D, a plurality of substrates M1-M4 are shown according to some aspects of the disclosure. The masks M1-M4 from FIGS. 2A-2D may correspond to being used in connection with substrates S1-S4, respectively, from FIGS. 1A-1D, in order to coat substrates S1-S4. For example, first mask M1 may be used as a mask for first substrate S1, second mask M2 may be used as a mask for second substrate S2, third mask M3 may be used as a mask for third substrate S3, and no mask M4 may be used for fourth substrate S4. Masks M1-M4 may be placed over substrates S1-S4 to block at least a first portion of the surface of the substrates S1-S4 and not block at least a second portion of the surface of the substrates S1-S4. The masks M1-M4 placed over the substrates S1-S4 may block at least a portion of a coating applied to the substrates S1-S4 from reaching the surface in the first portion and not block the coating applied to the substrates S1-S4 from reaching the surface in the second portion.

The masks M1-M4 may be of any desired shape depending on the predetermined coating arrangement intended for the substrates S1-S4 (e.g., desired regions to be coated/uncoated). In some non-limiting embodiments, the fourth substrate S4 may have a predetermined coating arrangement of being completely coated by the coating such that no mask M4 is used.

The masks M1-M4 may be made from any suitable material. For example, the masks M1-M4 may be made from a material configured to prevent a coating applied to the substrates S1-S4 from contacting the surface of the region of the substrates S1-S4 blocked by the masks M1-M4. In some non-limiting examples, the masks M1-M4 may be made from stainless steel.

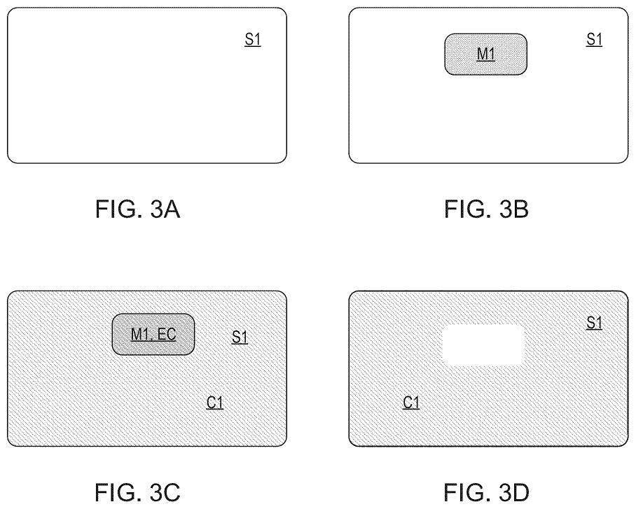

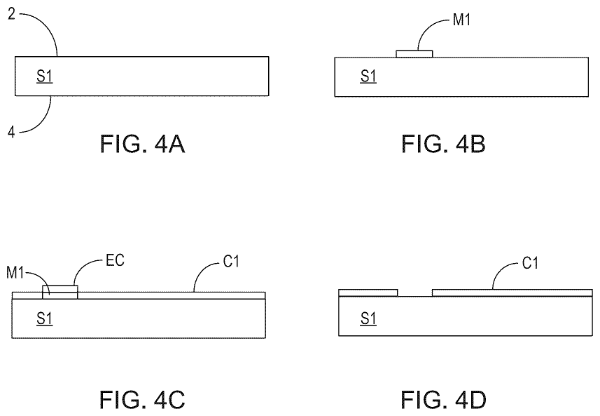

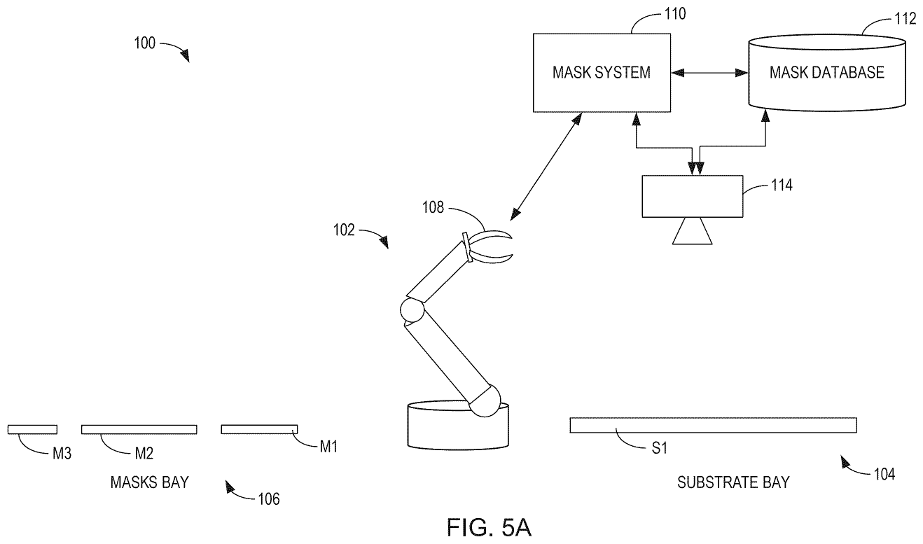

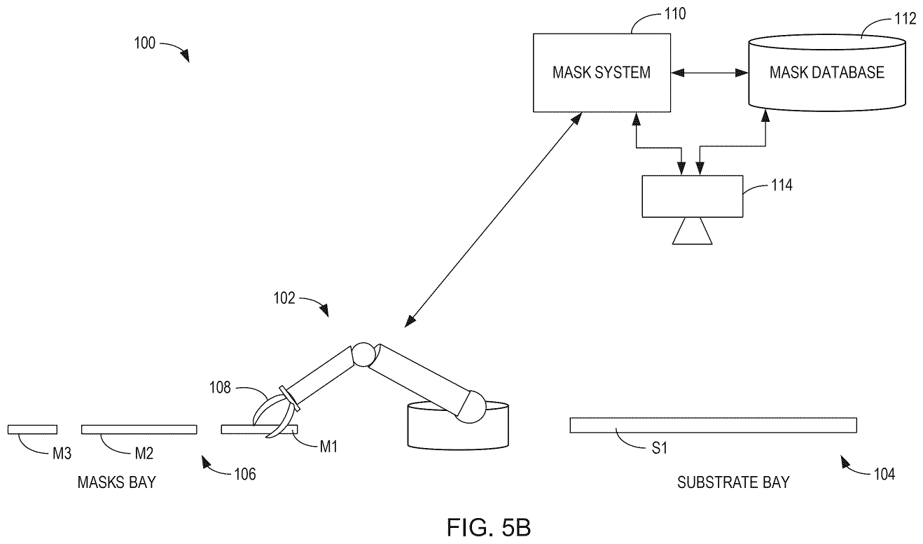

Referring to FIGS. 3A-4D, a substrate undergoing a process for producing a coated substrate using a mask is shown according to some aspects of the disclosure FIGS. 3A-3D correspond to FIGS. 4A-4D, respectively, wherein FIGS. 3A-3D show top views of the first substrate S1, and FIGS. 4A-4D show corresponding cross-sectional views of the first substrate S1.

Referring to FIGS. 3A and 4A, first substrate S1 may be uncoated and have a first surface 2 and an opposing second surface 4. The first surface 2 may be the surface intended to be masked and/or coated.

Referring to FIGS. 3B and 4B, a first mask M1 may be placed over the first substrate S1 (e.g., the first surface 2 thereof), thus forming a masked portion and an unmasked portion of the first substrate S1.

A coating may be applied over the masked first substrate S1 shown in FIGS. 3B and 4B to form the coated first substrate S1 shown in FIGS. 3C-3D and 4C-4D. A first coating C1 may be applied over the masked first substrate S1 so that both the masked portion and unmasked portion are coated with the first coating C1. The first mask M1 may be coated with the first coating C1. The portion of coating C1 applied over mask M1 may be considered excess coating EC, since the excess coating EC may be removed from the first substrate S1 during removal of the first mask M1. The first coating C1 may adhere to the portion of the first surface 2 corresponding to the unmasked portion and may not adhere to the portion of the first surface 2 corresponding to the masked portion. The first mask M1 may be removed from the first substrate S1 after application of the first coating C1.

Referring to FIGS. 3D and 4D, the coated first substrate S1 is shown after removal of the first mask M1 (and thus removal of excess coating EC). The resulting coated first substrate S1 may have a coated portion coated by the first coating C1 and an uncoated portion not coated by the first coating C1 due to the use of the first mask M1 during the coating process.

The first coating C1 may be any suitable coating layer or stack of coating layers. In some non-limiting embodiments or aspects, the first coating C1 may comprise at least one of a solar control coating, an antireflective coating, a low emissivity coating, or any combination thereof. The material of the one or more coating layers may include, for example dielectric layers, such as zinc oxide, zinc stannate, tin oxide, silicon nitride, titanium oxide, hafnium oxide, niobium oxide, bismuth oxide, lead oxide, indium oxide, silicon oxide, gallium oxide, vanadium oxide, and the like; metallic layers, such as silver, titanium, copper, aluminum, zinc, gold, and the like; or any combination thereof. The one or more coating layers of the first coating C1 may have the same or different thicknesses and may be arranged in any suitable order. In some non-limiting embodiments or aspects, the first coating C1 may comprise a conductive coating. In some non-limiting embodiments or aspects, the first coating C1 may comprise a paint, a stain, and/or an ink.

In some non-limiting embodiments or aspects, the region of the first substrate S1 uncoated by the first coating C1 may be strategically selected based on the application of the first substrate S1. For example, the first substrate S1 may comprise an automotive windshield, and the first coating C1 may comprise a solar control coating having coating layers that could interfere with certain sensors (e.g., radiation (e.g., infrared) emitted therefrom or detected thereby) of the vehicle, such that the uncoated portion(s) of the first substrate S1 is strategically arranged in regions interacting with the sensors. It will be appreciated that other examples of applications in which a portion of the first substrate S1 is desired to be uncoated are within the scope of the present disclosure.

The process for producing a coated substrate using a mask described in connection with FIGS. 3A-4D may be effected using the systems as shown and described hereinafter.

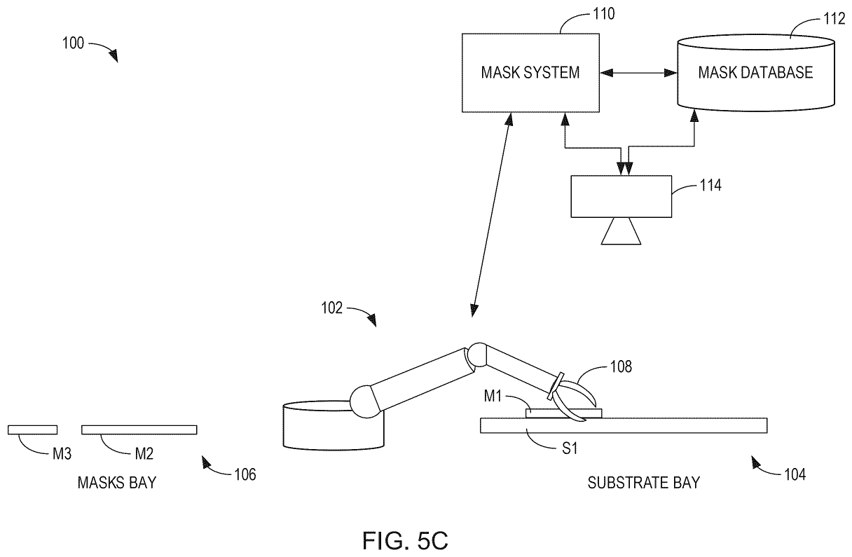

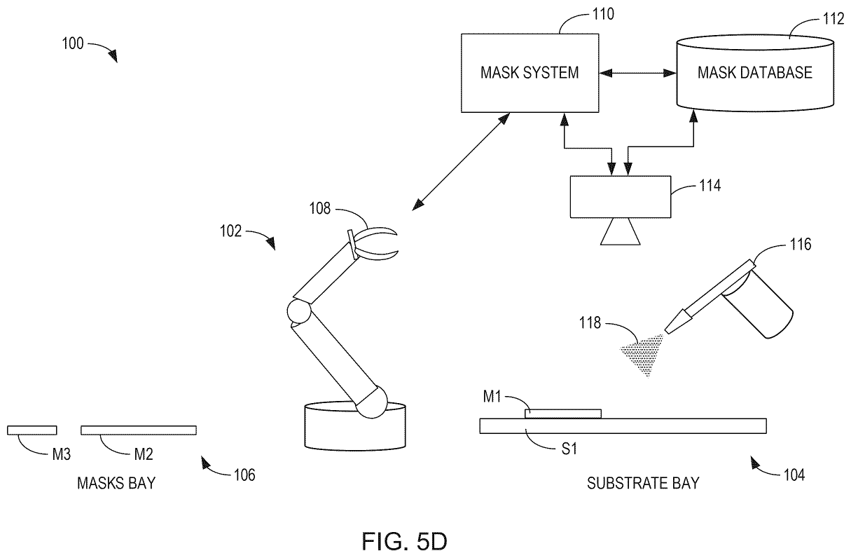

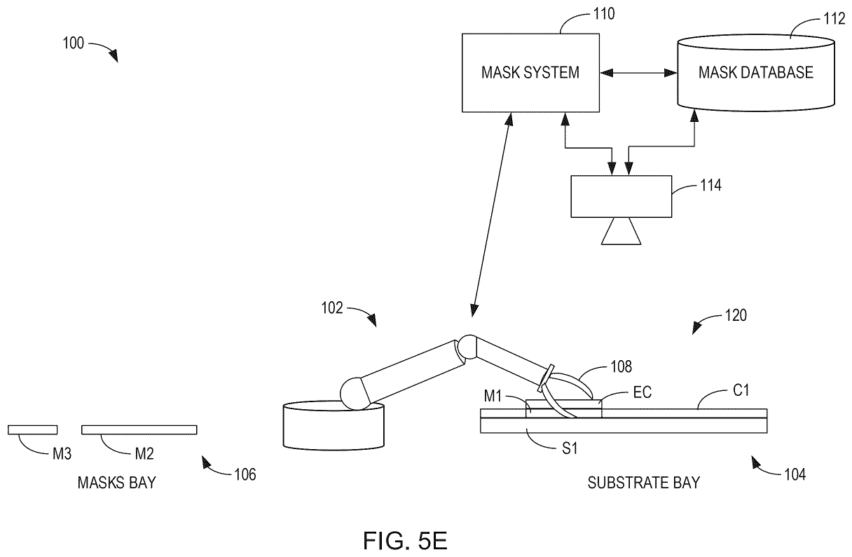

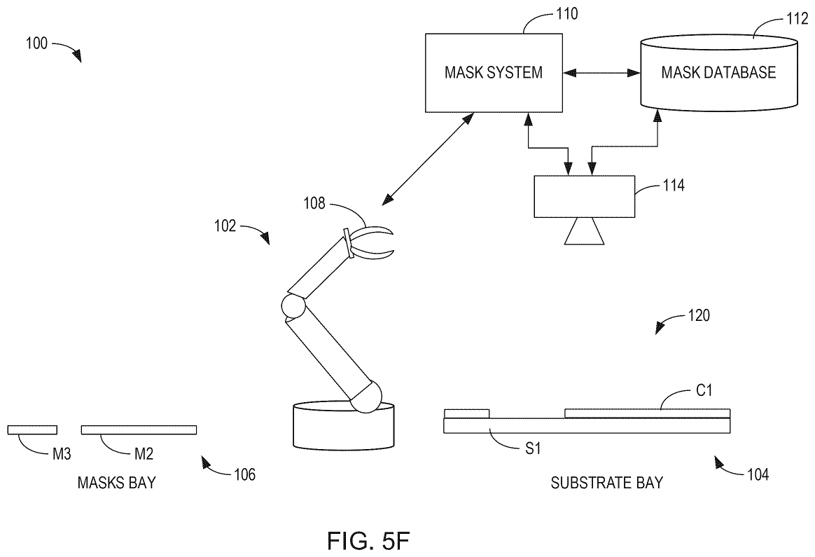

Referring to FIGS. 5A-5F a gantry system 100 is shown for producing a coated substrate, according to some aspects of the disclosure. The gantry system 100 may comprise a mechanical arm 102 positioned between a substrate bay 104 and a masks bay 106. The substrate bay 104 may contain one or more substrates (e.g., first substrate S1) to be coated by the gantry system 100. The masks bay 106 may contain one or more masks (e.g., first, second, and third masks M1-M3) that can be used by the gantry system 100 to coat the one or more substrates from the substrate bay 104.

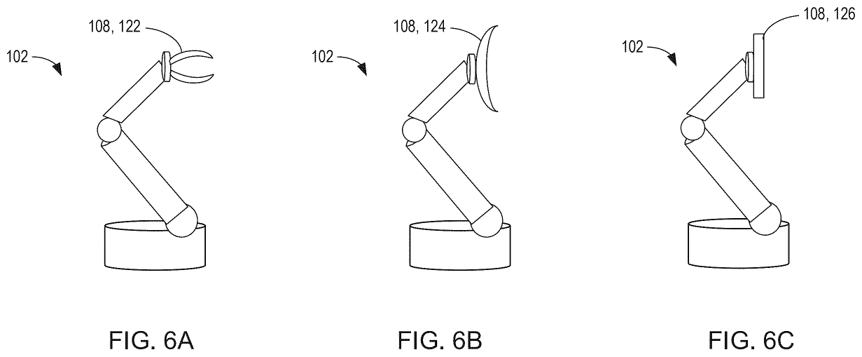

Referring to FIGS. 5A-5F and FIGS. 6A-6C, the mechanical arm 102 may comprise a robotic and/or other mechanical arm configured to automatically engage with the masks M1-M3 in the mask bay 106 and move the masks M1-M3 to and from the substrate bay 104 to mask the first substrate S1, during the process for coating the first substrate S1. The mechanical arm 102 may comprise an engager 108 configured to automatically engage with the masks M1-M3. For example, the engager 108 may pick up at least one of the masks M1-M3 and convey the at least one mask M1-M3 to the first substrate S1 to mask the first substrate S1.

Referring to FIGS. 6A-6C, the engager 108 may comprise any suitable arrangement for engaging with and moving the masks M1-M3. For example, the engager 108 in FIG. 6A may comprise a claw 122 configured to grab and move the masks M1-M3. For example, the engager 108 in FIG. 6B may comprise a suction cup 124 configured to grab and move the masks M1-M3. For example, the engager 108 in FIG. 6C may comprise a magnet 126 configured to grab and move the masks M1-M3. It will be appreciated that the specific embodiments of the engager 108 shown and described in FIGS. 6A-6C are non-limiting examples and other designs of the engager 108 that engage and move the masks M1-M3 are with the scope of the present disclosure.

Referring again to FIGS. 5A-5F, the gantry system 100 may comprise a mask system 110, a mask database 112, and a detection system 114.

The mask system 110 may communicate with at least one of mask database 112, detection system 114, and/or mechanical arm 102. The mask system 110 may receive messages from and/or transmit messages to at least one of these components. In some non-limiting embodiments or aspects, the mask system 110 may communicate at least one control instruction to at least one of mask database 112, detection system 114, and/or mechanical arm 102. The mask system 110 may comprise at least one computing device (e.g., user device) configured to receive input from a user of the gantry system 100 and/or to transmit and/or display at least one output generated by the gantry system 100.

The mask database 112 may be configured to store data. The mask database 112 may store associations between substrates (e.g., the identities thereof) and corresponding masks (the identities thereof). Each substrate processed by the gantry system 100 may comprise a substrate identifier that uniquely identifies each of the different substrates. Each mask used by the gantry system 100 may comprise a mask identifier that uniquely identifies each of the different masks. Associations between the substrates and the masks that are used in association with each of the substrates may be stored in the mask database 112. For example, considering the substrates S1-S4 in FIG. 1 and their corresponding respective masks (or lack of masks) M1-M4 in FIG. 2, the mask database 112 may store these associations (e.g., associations representing: S1-M1, S2-M2, S3-M3, S4-M4). These associations may indicate which mask(s) corresponds to which substrate(s) and vice versa) in response to querying of the mask database 112 (e.g., by mask system 110).

The substrate identifiers may identify the substrates and at least one property associated therewith. For example, the at least one property may comprise a physical property (e.g., at least one dimension), a chemical property (e.g., a chemical or material make-up), a treatment property (e.g., a coating arrangement intended for the substrate), associational property (e.g., mask(s) associated with the substrate), and the like.

The mask identifiers may identify the masks and at least one property associated therewith. For example, the at least one property may comprise a physical property (e.g., at least one dimension), a chemical property (e.g., a chemical or material make-up), a treatment property (e.g., intended location of the mask on the substrate), and/or associational property (e.g., substrates(s) associated with the mask), and the like.

The detection system 114 may be configured to identify substrates based on at least one characteristic of the substrate being analyzed by the detection system 114. The detection system 114 may detect the substrates (e.g., the identity and/or identifier thereof) in any suitable manner. For example, in some non-limiting embodiments, the detection system 114 may comprise a vision system that identifies the substrate based on one or more visual characteristic thereof. In some non-limiting embodiments, the detection system 114 may comprise a chemical analyzer configured to identify the substrates based on one or more chemical or material property thereof, as determined by the analyzer. In some non-limiting embodiments, the detection system 114 may comprise a computer device configured to read at least one computer-readable code (e.g., a bar code, a QR code, and the like) arranged on or in association with the substrates. The detection system 114 may communicate data used to identify the substrate identity and/or the substrate identity to at least one of the mask system 110 and/or the mask database 112.

The ensuing embodiments will be discussed in the context of the detection system 114 comprising a vision system, but these embodiments can be adapted to other forms of the detection system 114 described herein capable of identifying substrates.

Referring to FIG. 5A, the detector system 114 may comprise a vision system configured to automatically detect that the first substrate S1 has a first substrate identity. The vision system of the detector system 114 may comprise at least one visual analyzer, such as a camera configured to visually analyze the first substrate S1. For example, a Teledyne camera system or other camera system may be used as the detector system 114.

The vision system of the detector system 114 may automatically detect one or more dimensions and/or shapes of the first substrate S1 (or a portion thereof) to automatically identify the first substrate.

The detector system 114 may automatically identify the first substrate S1, or the detector system 114 may automatically communicate the detected dimensions/shape to at least one of the mask system 110 and/or the mask database 112 to identify the first substrate S1 based on the transmitted detected dimensions/shape. For example, mask system 110 may query mask database 112 based on the dimensions, and mask database 112 may return the identity of the first substrate S1 based on a stored association between the detected dimension/shape and the first substrate S1.

In some non-limiting embodiments or aspects, the first substrate S1 may be rotated about the horizontal plane (physically (e.g., by the mechanical arm 102) and/or virtually (e.g., by the detector system 114)) between 0 and 360° until the positioning of the first substrate S1 matches one of the stored dimensions/shapes associated with substrates.

In response to determining the identity of the first substrate S1, the mask system 110 may automatically determine that a first mask M1 of a plurality of masks M1-M3 is associated with the first substrate S1 and should be used by the gantry system 100 during coating of the first substrate S1. The mask system 110 may automatically determine the first mask M1 based on the associations stored in the mask database 112, the associations indicating that the first mask M1 corresponds to the first substrate S1.

Referring to FIG. 5B, in response to determining that the first mask M1 should be used, the mask system 110 may transmit a control signal to the mechanical arm 102. The control signal may cause the mechanical arm 102 to move to retrieve the first mask M1 and to place the first mask M1 on the first substrate S1.

As shown in FIG. 5A, the mechanical arm 102 may begin in an initial position. As shown in FIG. 5B, in response to receiving the control signal, the mechanical arm 102 may move (e.g., pivot, raise, lower, translate, and the like) to the masks bay 106 to the location containing the first mask M1 associated with the first substrate S1. The engager 108 of the mechanical arm 102 may engage with (e.g., grab, suction, magnetically attract, adhere, and the like) the first mask M1 so as to move the first mask M1.

Referring to FIG. 5C, the first mask M1 engaged by the engager 108 may be moved to the first substrate S1 by moving the mechanical arm 102 from the masks bay 106 to the position of the first substrate S1 in the substrate bay 104. The mechanical arm 102 may place the first mask M1 at the desired location on the first substrate S1, such as based on control instructions from the mask system 110 based on data stored in the mask database 112.

In response to placing the first mask M1 over the first substrate S1, the detector system 114 may automatically detect whether the first mask M1 is correctly aligned over the first substrate S1. The detector system 114 may use its vision system (e.g., camera) to detect the location of the first mask M1 over the surface of the first substrate S1 and compare the current location of the first mask M1 to the desired location of the first mask M1. If the first mask M1 is not correctly located over the first substrate S1, the mask system 110 may transmit a further control instruction to cause the mechanical arm 102 to correct the positioning of the first mask M1 on the first substrate S1. This process may be repeated until it is determined that the first mask M1 is correctly positioned on the first substrate S1.

Referring to FIG. 5D, in response to correctly arranging the first mask M1 over the first substrate S1, a coating applicator 116 may be configured to apply at least one coating composition 118 to the first substrate S1 to form the first coating C1 (see FIG. 5D). The coating applicator 116 may apply the coating composition 118 over both the first mask M1 and the unmasked portion of the first substrate S1. The coating applicator 116 may comprise any suitable device for coating substrates. Non-limiting examples of the coating applicator 116 may comprise at least one of a vacuum coating applicator; a sputter coating applicator, such as a magnetron sputtering vapor deposition (MSVD) applicator, an ion beam sputtering (IBS) applicator, a spin coating applicator, a spray coating applicator, a curtain coating applicator, a draw-down coating applicator, an in-mold coating applicator, a doctor blade coating applicator, and the like.

Referring to FIG. 5E, the coating composition 118 (see FIG. 5D) applied by the coating applicator 116 may adhere to the first mask M1 as excess coating EC, thus shielding the masked portion of the first substrates S1 from contact with the coating composition 118 and preventing the first coating C1 from adhering to the masked portion of the first substrate S1. The first coating C1 may adhere to the unmasked portion of the first substrate S1.

With continued reference to FIG. 5E, a remover may be configured to remove the first mask M1 (and the excess coating EC thereover) from the first substrate S1 after the coating applicator 116 (see FIG. 5D) applies the coating composition 118 thereon. For example, the remover may comprise the mechanical arm 102. The mechanical arm 102 may engage with the first mask M1 and/or the excess coating EC to remove them from the first substrate S1. The mechanical arm 102 may move the first mask M1 from the substrate bay 104 back to the masks bay 106 so that the first mask M1 can be used again to mask another substrate in a subsequent coating process.

In some non-limiting embodiments, multiple coatings may be applied over the first substrate S1 and/or multiple regions of the first substrate S1 may be separately coated.

Referring to FIG. 5F, after the coating application process and removal of the first mask M1, the coated first substrate S1 (e.g., coated substrate 120) may be completed. Therefore, the first coating C1 was selectively applied to first portions of the first substrate S1 and selectively prevented from being applied to second portions of the first substrate S1.

Referring again to FIGS. 5A-5F the gantry system 100 has been shown and described for producing the coated first substrate S1 with the first coating C1. However, it will be appreciated that this same gantry system 100 may be used to coat a plurality of different substrates using a plurality of different mask. For example, the second substrate S2 may be coated in the substrate bay 104 using the second mask M2, the third substrate S3 may be coated in the substrate bay 104 using the third mask M3, and/or the fourth substrate S4 may be coated in the substrate bay 104 using no mask M4 (see also FIGS. 1A-2D).

Therefore, the gantry system 100 may execute a method comprising: providing the second substrate S2 comprising a first surface and an opposing second surface, the second substrate S2 having a second substrate identity from the plurality of substrate identities (e.g., different from the substrate identity of the first substrate S1); automatically detecting (e.g., with mask system 110, mask database 112, and/or detection system 114) that the second substrate S2 has the second substrate identity; in response to detecting that the second substrate S2 has the second substrate identity, determining (e.g., with mask system 110, mask database 112, and/or detection system 114) a second mask M2 of the plurality of masks associated with the second substrate identity based on the associations stored in the mask database 112 between the plurality of substrate identities and the plurality of masks; in response to determining the second mask M2, automatically retrieving, with the mechanical arm 102, the second mask M2; and placing, with the mechanical arm 102, the second mask M2 over the first surface of the second substrate S2. This masked second substrate S2 may be coated using the coating applicator 116 as previously described.

The gantry system 100 is configured to coat a plurality of different substrates S1-S4 using a plurality of different masks M1-M4 by retrieving the mask corresponding to the substrate automatically and in response to the gantry system 100 determining the specific substrate being coated from a plurality of substrates.

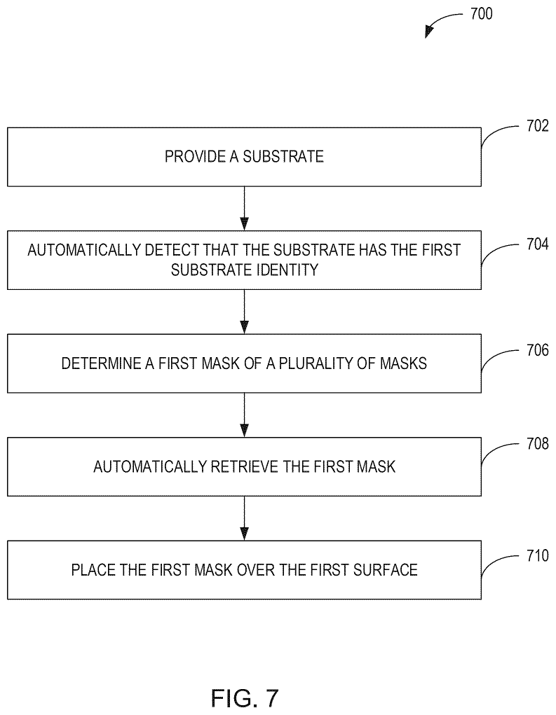

Referring now to FIG. 7, shown is a flow diagram of a method 700 for producing a coated substrate using a mask, according to some non-limiting embodiments or aspects. The steps shown in FIG. 7 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

At a step 702, the method 700 may include providing a substrate comprising a first surface and an opposing second surface, the substrate having a first substrate identity from a plurality of substrate identities.

At a step 704, the method 700 may include automatically detecting, with at least one processor, that the substrate has the first substrate identity. For example, at least one of the mask system 110, the mask database 112, and/or the detection system 114 may automatically detect that the substrate has the first substrate identity.

At a step 706, the method 700 may include, in response to detecting that the substrate has the first substrate identity, determining, with at least one processor, a first mask of a plurality of masks associated with the first substrate identity based on associations stored in a database between the plurality of substrate identities and the plurality of masks. For example, at least one of the mask system 110, the mask database 112, and/or the detection system 114 may determine a first mask of a plurality of masks associated with the first substrate identity based on associations stored in mask database 112 between the plurality of substrate identities and the plurality of masks.

At a step 708, the method 700 may include, in response to determining the first mask, automatically retrieving, with at least one mechanical arm, the first mask. For example, mechanical arm 102 may automatically retrieve the first mask.

At a step 710, the method 700 may include placing, with the at least one mechanical arm, the first mask over the first surface. For example, mechanical arm 102 may place the first mask over the first surface.

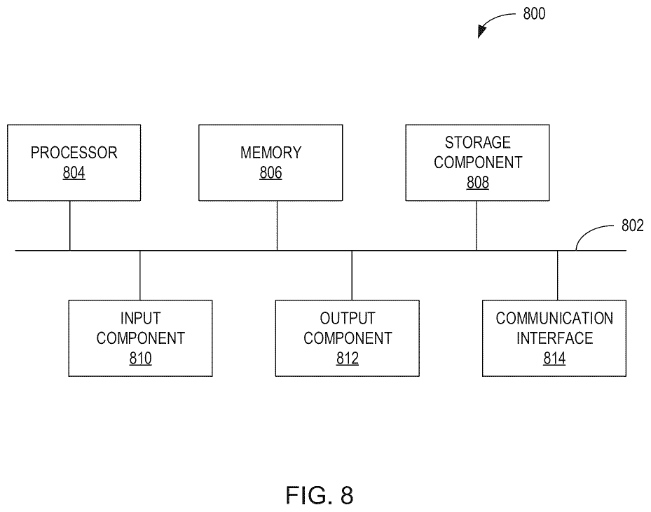

Referring now to FIG. 8, shown is a diagram of example components of a device 800 according to non-limiting embodiments. Device 800 may correspond to mechanical arm 102, mask system 110, mask database 112, and/or detection system 114, as an example. In some non-limiting embodiments, such systems or devices may include at least one device 800 and/or at least one component of device 800. The number and arrangement of components shown are provided as an example. In some non-limiting embodiments, device 800 may include additional components, fewer components, different components, or differently arranged components than those shown. Additionally, or alternatively, a set of components (e.g., one or more components) of device 800 may perform one or more functions described as being performed by another set of components of device 800.

As shown in FIG. 8, device 800 may include a bus 802, a processor 804, memory 806, a storage component 808, an input component 810, an output component 812, and a communication interface 814. Bus 802 may include a component that permits communication among the components of device 800. In some non-limiting embodiments, processor 804 may be implemented in hardware, firmware, or a combination of hardware and software. For example, processor 804 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 806 may include random access memory (RAM), read only memory (ROM), and/or another type of dynamic or static storage device (e.g., flash memory, magnetic memory, optical memory, etc.) that stores information and/or instructions for use by processor 804.

With continued reference to FIG. 8, storage component 808 may store information and/or software related to the operation and use of device 800. For example, storage component 808 may include a hard disk (e.g., a magnetic disk, an optical disk, a magneto-optic disk, a solid-state disk, etc.) and/or another type of computer-readable medium. Input component 810 may include a component that permits device 800 to receive information, such as via user input (e.g., a touch screen display, a keyboard, a keypad, a mouse, a button, a switch, a microphone, etc.). Additionally, or alternatively, input component 810 may include a sensor for sensing information (e.g., a global positioning system (GPS) component, an accelerometer, a gyroscope, an actuator, etc.). Output component 812 may include a component that provides output information from device 800 (e.g., a display, a speaker, one or more light-emitting diodes (LEDs), etc.). Communication interface 814 may include a transceiver-like component (e.g., a transceiver, a separate receiver and transmitter, etc.) that enables device 800 to communicate with other devices, such as via a wired connection, a wireless connection, or a combination of wired and wireless connections. Communication interface 814 may permit device 800 to receive information from another device and/or provide information to another device. For example, communication interface 814 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 800 may perform one or more processes described herein. Device 800 may perform these processes based on processor 804 executing software instructions stored by a computer-readable medium, such as memory 806 and/or storage component 808. A computer-readable medium may include any non-transitory memory device. A memory device includes memory space located inside of a single physical storage device or memory space spread across multiple physical storage devices. Software instructions may be read into memory 806 and/or storage component 808 from another computer-readable medium or from another device via communication interface 814. When executed, software instructions stored in memory 806 and/or storage component 808 may cause processor 804 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The following numbered clauses are illustrative of various aspects of the disclosure:

Clause 1: A method for masking substrates, comprising: providing a substrate comprising a first surface and an opposing second surface, the substrate having a first substrate identity from a plurality of substrate identities; automatically detecting, with at least one processor, that the substrate has the first substrate identity; in response to detecting that the substrate has the first substrate identity, determining, with at least one processor, a first mask of a plurality of masks associated with the first substrate identity based on associations stored in a database between the plurality of substrate identities and the plurality of masks; in response to determining the first mask, automatically retrieving, with at least one mechanical arm, the first mask; and placing, with the at least one mechanical arm, the first mask over the first surface.

Clause 2: The method of clause 1, wherein with the first mask over the first surface, at least one first portion of the first surface is blocked by the first mask and at least one second portion of the first surface is not blocked by the first mask.

Clause 3: The method of clause 2, further comprising applying at least one coating composition over the first mask such that the coating composition adheres to the first surface on the at least one second portion of the first surface and does not adhere to the first surface on the at least one first portion of the first surface.

Clause 4: The method of clause 3, further comprising removing the first mask after applying the at least one coating composition.

Clause 5: The method of clause 3 or 4, wherein the coating composition comprises at least one of a solar control coating, an antireflective coating, a low emissivity coating, or any combination thereof.

Clause 6: The method of any of clauses 1-5, wherein the substrate comprises a glass sheet.

Clause 7: The method of any of clauses 1-6, wherein automatically detecting that the substrate has the first substrate identity comprises automatically detecting a dimension of the substrate, wherein the database stores associations between substrate dimensions and the plurality of substrate identities.

Clause 8: The method of any of clauses 1-7, wherein automatically retrieving the first mask with the at least one mechanical arm comprises: moving the at least one mechanical arm to a first location comprising the first mask; engaging the first mask with the at least one mechanical arm; and moving the at least one mechanical arm to the substrate.

Clause 9: The method of any of clauses 1-8, further comprising: providing a second substrate comprising a first surface and an opposing second surface, the second substrate having a second substrate identity from the plurality of substrate identities; automatically detecting, with at least one processor, that the second substrate has the second substrate identity; in response to detecting that the second substrate has the second substrate identity, determining, with at least one processor, a second mask of the plurality of masks associated with the second substrate identity based on the associations stored in the database between the plurality of substrate identities and the plurality of masks; in response to determining the second mask, automatically retrieving, with the at least one mechanical arm, the second mask; and placing, with the at least one mechanical arm, the second mask over the first surface of the second substrate.

Clause 10: The method of any of clauses 1-9, further comprising: in response to placing the first mask over the first surface, detecting, with at least one processor, correct alignment of the first mask over the first substrate.

Clause 11: A system for masking substrates, comprising: a database storing associations between a plurality of substrate identities and a plurality of masks; at least one processor configured to: automatically detect that a substrate has a first substrate identity of the plurality of substrate identities, the substrate comprising a first surface and an opposing second surface; and in response to detecting that the substrate has the first substrate identity, determine a first mask of the plurality of masks associated with the first substrate identity based on the associations stored in the database; and at least one mechanical arm configured to: in response to determining the first mask, automatically retrieve the first mask; and place the first mask over the first surface.

Clause 12: The system of clause 11, wherein with the first mask over the first surface, at least one first portion of the first surface is blocked by the first mask and at least one second portion of the first surface is not blocked by the first mask.

Clause 13: The system of clause 12, further comprising: an applicator configured to apply at least one coating composition over the first substrate such that the coating composition adheres to the first surface on the at least one second portion of the first surface and does not adhere to the first surface on the at least one first portion of the first surface.

Clause 14: The system of clause 13, further comprising: a remover configured to remove the first mask after applying the at least one coating composition.

Clause 15: The system of clause 13 or 14, wherein the coating composition comprises at least one of a solar control coating, an antireflective coating, a low emissivity coating, or any combination thereof.

Clause 16: The system of any of clauses 11-15, wherein the substrate comprises a glass sheet.

Clause 17: The system of any of clauses 11-16, wherein automatically detecting that the substrate has the first substrate identity comprises the at least one processor automatically detecting a dimension of the substrate, wherein the database stores associations between substrate dimensions and the plurality of substrate identities.

Clause 18: The system of any of clauses 11-17, wherein automatically retrieving the first mask with the at least one mechanical arm comprises the at least one mechanical arm being configured to: move the at least one mechanical arm to a first location comprising the first mask; engage the first mask with the at least one mechanical arm; and move the at least one mechanical arm to the substrate.

Clause 19: The system of any of clauses 11-18, wherein the at least one processor is further configured to: automatically detect that a second substrate has a second substrate identity of the plurality of substrate identities, the second substrate comprising a first surface and an opposing second surface; in response to detecting that the second substrate has the second substrate identity, determine a second mask of the plurality of masks associated with the second substrate identity based on the associations stored in the database; and wherein the at least one mechanical arm is further configured to: in response to determining the second mask, automatically retrieve the second mask; and place the second mask over the first surface of the second substrate.

Clause 20: The system of any of clauses 11-19, the at least one processor is further configured to: in response to placing the first mask over the first surface, detect correct alignment of the first mask over the first substrate.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A method for masking substrates, comprising:
providing a substrate comprising a first surface and an opposing second surface, the substrate having a first substrate identity from a plurality of substrate identities;
automatically detecting, with at least one processor, that the substrate has the first substrate identity;
in response to detecting that the substrate has the first substrate identity, determining, with at least one processor, a first mask of a plurality of masks associated with the first substrate identity based on associations stored in a database between the plurality of substrate identities and the plurality of masks;
in response to determining the first mask, automatically retrieving, with at least one mechanical arm, the first mask; and
placing, with the at least one mechanical arm, the first mask over the first surface.

2. The method of claim 1, wherein with the first mask over the first surface, at least one first portion of the first surface is blocked by the first mask and at least one second portion of the first surface is not blocked by the first mask.

3. The method of claim 2, further comprising applying at least one coating composition over the first mask such that the coating composition adheres to the first surface on the at least one second portion of the first surface and does not adhere to the first surface on the at least one first portion of the first surface.

4. The method of claim 3, further comprising removing the first mask after applying the at least one coating composition.

5. The method of claim 3, wherein the coating composition comprises at least one of a solar control coating, an antireflective coating, a low emissivity coating, or any combination thereof.

6. The method of claim 1, wherein the substrate comprises a glass sheet.

7. The method of claim 1, wherein automatically detecting that the substrate has the first substrate identity comprises automatically detecting a dimension of the substrate, wherein the database stores associations between substrate dimensions and the plurality of substrate identities.

8. The method of claim 1, wherein automatically retrieving the first mask with the at least one mechanical arm comprises:
moving the at least one mechanical arm to a first location comprising the first mask;
engaging the first mask with the at least one mechanical arm; and
moving the at least one mechanical arm to the substrate.

9. The method of claim 1, further comprising:
providing a second substrate comprising a first surface and an opposing second surface, the second substrate having a second substrate identity from the plurality of substrate identities;
automatically detecting, with at least one processor, that the second substrate has the second substrate identity;
in response to detecting that the second substrate has the second substrate identity, determining, with at least one processor, a second mask of the plurality of masks associated with the second substrate identity based on the associations stored in the database between the plurality of substrate identities and the plurality of masks;
in response to determining the second mask, automatically retrieving, with the at least one mechanical arm, the second mask; and
placing, with the at least one mechanical arm, the second mask over the first surface of the second substrate.

10. The method of claim 1, further comprising:
in response to placing the first mask over the first surface, detecting, with at least one processor, correct alignment of the first mask over the first substrate.

11. A system for masking substrates, comprising:
a database storing associations between a plurality of substrate identities and a plurality of masks;
at least one processor configured to:
automatically detect that a substrate has a first substrate identity of the plurality of substrate identities, the substrate comprising a first surface and an opposing second surface; and
in response to detecting that the substrate has the first substrate identity, determine a first mask of the plurality of masks associated with the first substrate identity based on the associations stored in the database; and
at least one mechanical arm configured to:
in response to determining the first mask, automatically retrieve the first mask; and
place the first mask over the first surface.

12. The system of claim 11, wherein with the first mask over the first surface, at least one first portion of the first surface is blocked by the first mask and at least one second portion of the first surface is not blocked by the first mask.

13. The system of claim 12, further comprising:
an applicator configured to apply at least one coating composition over the first substrate such that the coating composition adheres to the first surface on the at least one second portion of the first surface and does not adhere to the first surface on the at least one first portion of the first surface.

14. The system of claim 13, further comprising:
a remover configured to remove the first mask after applying the at least one coating composition.

15. The system of claim 13, wherein the coating composition comprises at least one of a solar control coating, an antireflective coating, a low emissivity coating, or any combination thereof.

16. The system of claim 11, wherein the substrate comprises a glass sheet.

17. The system of claim 11, wherein automatically detecting that the substrate has the first substrate identity comprises the at least one processor automatically detecting a dimension of the substrate, wherein the database stores associations between substrate dimensions and the plurality of substrate identities.

18. The system of claim 11, wherein automatically retrieving the first mask with the at least one mechanical arm comprises the at least one mechanical arm being configured to:
move the at least one mechanical arm to a first location comprising the first mask;
engage the first mask with the at least one mechanical arm; and
move the at least one mechanical arm to the substrate.

19. The system of claim 11,
wherein the at least one processor is further configured to:
automatically detect that a second substrate has a second substrate identity of the plurality of substrate identities, the second substrate comprising a first surface and an opposing second surface;
in response to detecting that the second substrate has the second substrate identity, determine a second mask of the plurality of masks associated with the second substrate identity based on the associations stored in the database; and
wherein the at least one mechanical arm is further configured to:
in response to determining the second mask, automatically retrieve the second mask; and
place the second mask over the first surface of the second substrate.

20. The system of claim 11, the at least one processor is further configured to: in response to placing the first mask over the first surface, detect correct alignment of the first mask over the first substrate.
